(19) United States
(12) Patent Application Publication
(10) Pub. No.: US 2026/0167418 A1
(43) Pub. Date: Jun. 18, 2026

(54) REFUSE INTAKE AND FLOW DETECTING

(71) Applicant: The Heil Co., Chattanooga, TN (US)

(72) Inventor: Jonathan Paul Shadrick, Trenton, GA (US)

(21) Appl. No.: 19/425,464

(22) Filed: Dec. 18, 2025

Related U.S. Application Data
(60) Provisional application No. 63/735,818, filed on Dec. 18, 2024.

(51) Int. Cl. B65F 3/22; B65F 3/02; B65F 3/04; B65F 3/14

(52) U.S. Cl. CPC B65F 3/22; B65F 3/041; B65F 2003/0269; B65F 2003/146

(57) ABSTRACT

Systems for detecting a material flow anomaly affecting a packer of a refuse collection vehicle include a vehicle chassis, a refuse body on the vehicle chassis, an intake sensor, and a controller. The vehicle chassis defines a forward and rearward direction of travel. The refuse body includes a hopper, a storage container, and a packer. The hopper provides a refuse intake volume. The storage container provides a refuse storage volume. The packer is configured to transfer refuse from the intake volume of the hopper into the storage volume of the storage container and to pack waste within the storage volume. The intake sensor is configured to monitor the refuse intake volume of the hopper. The controller is configured to determine based on data received from the intake sensor that a condition of the refuse intake volume indicates a material flow anomaly affecting the packer.

### CROSS-REFERENCE TO RELATED APPLICATION

This application claims the benefit of the U.S. Provisional Patent Application No. 63/735,818, filed Dec. 18, 2024, which is incorporated herein by reference in its entirety.

### TECHNICAL FIELD

This disclosure relates to the field of refuse collection, storage, and compaction.

### BACKGROUND

Refuse collection vehicles are typically used to pick up quantities of refuse (e.g., garbage, waste, recyclables, etc.) for hauling to a designated area, such as a landfill, transfer station, or material recovery facility. These vehicles hold the refuse in a relatively large storage container supported on the vehicle chassis. Many refuse collection vehicles include an onboard system-colloquially called a “packer”—that transfers refuse from an intake area (e.g., a hopper) into the storage container and compacts the refuse within the storage container. Compacting the refuse increases the volume that the vehicle can hold in the storage container before the vehicle must travel to the designated area and eject the load.

### SUMMARY

Aspects of this disclosure are directed to vehicles, systems, and techniques that facilitate refuse collection, storage, and compaction.

In one aspect, a refuse collection vehicle includes: a vehicle chassis defining a forward and rearward direction of travel, and a refuse body on the vehicle chassis. The refuse body includes: a hopper providing a refuse intake volume, and a storage container rearward of the hopper. The storage container provides a refuse storage volume. The refuse body further includes a packer configured to transfer refuse from the intake volume of the hopper into the storage volume of the storage container and to pack waste within the storage volume. The refuse collection vehicle further includes: an intake sensor configured to monitor the refuse intake volume of the hopper, and a controller configured to determine based on data received from the intake sensor that a condition of the refuse intake volume indicates a material flow anomaly affecting the packer.

In another aspect combinable with the previous aspect, the intake sensor includes a contactless sensor oriented in a detection direction toward the refuse intake volume. The contactless sensor includes at least one of a camera, a vision sensor, an object distance sensor, or an object detection sensor.

In another aspect combinable with one or more of the previous aspects, the controller is further configured to adapt operations of the packer in response to detecting a material flow anomaly.

In another aspect combinable with one or more of the previous aspects, the controller is further configured to trigger a visible or audible alert in response to detecting a material flow anomaly.

In another aspect combinable with one or more of the previous aspects, the refuse body further includes a packer load sensor configured to monitor a load applied to or by the packer. In this aspect, the controller is further configured to determine whether packer load data indicates a material flow anomaly affecting the packer. In this aspect, the packer includes an auger, and the load includes a torque associated with the auger.

In another aspect combinable with one or more of the previous aspects, the data received from the intake sensor includes image data. In this aspect, the controller is configured to determine the condition of the refuse intake volume by performing a pixel analysis on the image data. In this aspect, the pixel analysis includes an image classification based on a model trained to identify a visible signature of at least one of the auger or the hopper.

In another aspect combinable with one or more of the previous aspects, the data received from the intake sensor includes distance data. In this aspect, the controller is configured to determine the condition of the refuse intake volume by comparing the distance data to a predetermined threshold.

Particular implementations of the subject matter described in this specification can be implemented so as to realize one or more material advantages. For example, providing automated techniques for detecting material flow anomalies affecting the packer of a refuse collecting system/vehicle may [i] prevent or reduce the likelihood of leakage and spillage from overfilled hoppers; [ii] alleviate operators from the burden of manually monitoring a refuse intake volume (e.g., the hopper on a refuse collection vehicle); [iii] detect such anomalies more quickly when they are easier to resolve; and [iv] increase operational efficiency and energy efficiency by promoting optimal packer operations.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 is a side view of a side-loading refuse collection vehicle featuring various aspects of the present disclosure.

FIG. 2 is a top view of the vehicle of FIG. 1 with a portion of the refuse collecting body hidden to show the internal storage volume of the storage container.

FIG. 3 is an enlarged portion of the top view of FIG. 2.

FIG. 4A is an enlarged top view of the vehicle of FIG. 1 illustrating an intake sensor oriented in a detection direction toward a refuse intake volume occupied by refuse.

FIG. 4B is an enlarged side view of the vehicle of FIG. 1 illustrating an intake sensor oriented in a detection direction toward a refuse intake volume occupied by refuse.

FIG. 5 is a first plot of a packer load data stream over the course of one or more refuse collecting routes.

FIG. 6 is a second plot of a packer load data stream following a service event.

FIG. 7 is a flowchart of a process that includes detecting a material flow anomaly affecting a packer.

FIG. 7A is a display of a user interface system displaying an alert.

FIG. 8 is a flowchart of a process that includes determining, based on packer load data, that a packer is operating in an idle state.

FIG. 9 is a diagram depicting a control system for controlling one or more operational components of a refuse collection vehicle.

### DETAILED DESCRIPTION

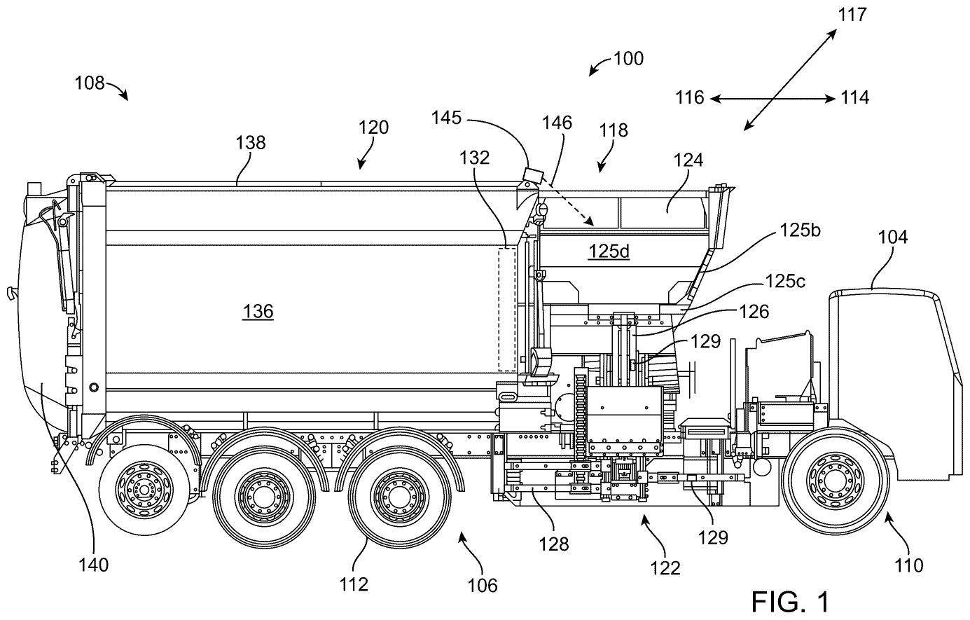

FIGS. 1-4B depict a vehicle 100 for collecting, packing, and transporting refuse (e.g., garbage, waste, recyclables, etc.) to a designated area, such as a landfill, transfer station, or material recovery facility. Refuse collection vehicles such as vehicle 100 are often described colloquially as garbage collection vehicles or just “garbage trucks.”

Refuse collection vehicle 100 includes a cab 104, a chassis 106, and a refuse collecting body 108. Cab 104 includes a compartment for a driver of vehicle 100. The compartment is equipped with controls that enable the driver to operate various elements of chassis 106 and body 108 and one or more displays that enable the driver to monitor such elements. Chassis 106 includes a power train 110 (e.g., a diesel, CNG, or electric power train). Power train 110, which includes a prime mover and a drivetrain, converts and transfers motive power to the wheels 112 that move vehicle 100 on a road surface along a forward direction of travel 114 and a rearward direction of travel 116. The direction across vehicle 100 and orthogonal to the forward/rearward directions is a transverse direction 117.

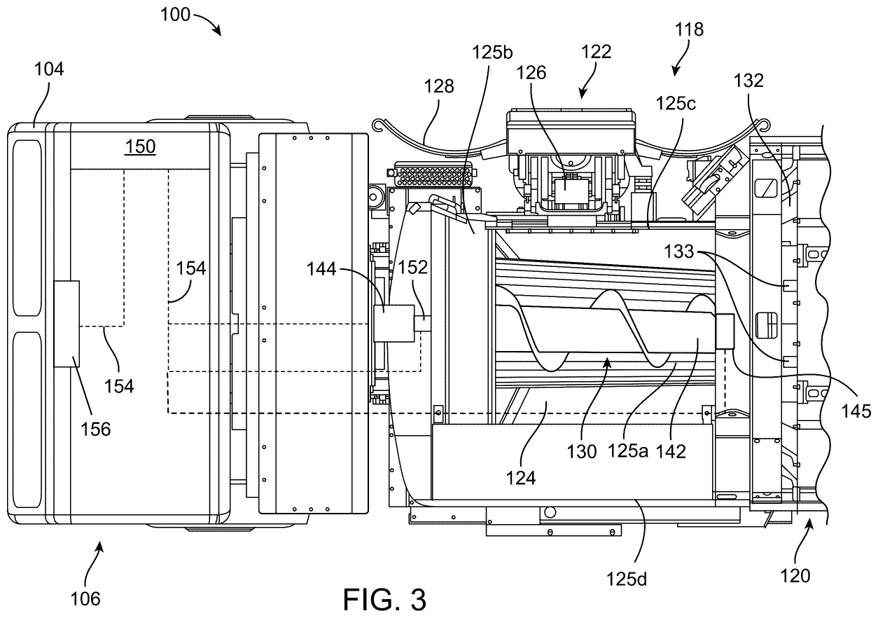

Refuse collecting body 108 includes an intake system 118, a storage container 120, a packer 130, an ejector 132, and a tailgate 140. Intake system 118 includes a lift 122 and a hopper 124. As discussed further below, one or more components of intake system 118, storage container 120, packer 130, ejector 132, and tailgate 140 are controlled by an onboard computing system including a logical controller 150 (see FIG. 3).

Lift 122 is operable to transfer the contents of residential refuse containers into storage container 120 via hopper 124. In this example, lift 122 includes a side-loading arm assembly including a reach (not shown), a mast 126, and a grabber 128. During use, when vehicle 100 pulls up to a residential refuse container, lift 122 performs a dump-cycle “service event” that includes: (i) moving the grabber 128 in the transverse direction away from the vehicle and toward the container via the reach; (ii) engaging (e.g., grasping) the container with the grabber 128; (iii) moving the grabber 128 with the container back toward the vehicle via the reach; (iv) raising the grabber 128 and the container vertically along the mast 126; and (v) dumping the contents of the container into the hopper 124. A set of one or more lift sensors 129 monitor operation of lift 122 during such a dump cycle.

Storage container 120 provides a refuse storage volume defined (at least in part) by a floor 134, lateral side walls 136, and a cover 138. Ejector 132 features a movable panel that provides a front wall of the storage volume, separating storage container 120 from hopper 124. Tailgate 140 provides the storage volume's rear wall.

Hopper 124 is located forward of storage container 120. Hopper 124 provides a refuse intake volume defined (at least in part) by a floor 125a, a front wall 125b facing cab 104, a loading-side wall 125c facing lift 122, an opposite port-side wall 125d, and the movable panel of ejector 132. When lift 122 performs a dump cycle, the grabber 128 and the refuse container it holds are raised and at least partially upended over the loading-side wall 125c to deposit the container's contents into the intake volume of hopper 124.

An intake sensor 145 monitors the refuse intake volume of hopper 124. In this example, intake sensor 145 is a contactless sensor mounted above the refuse intake volume (e.g., on an elevated edge or surface of hopper 124 or storage container 120). In this way, intake sensor 145 monitors the condition of the intake volume from a remote location at a distance from incoming refuse. To facilitate remote monitoring, intake sensor 145 is oriented in a detection direction 146 toward the hopper's refuse intake volume. The detection direction 146 is tilted downward from horizontal at a declining angle of depression, e.g., between about 10-80 degrees, such as between about 20-70 degrees, between about 25-65 degrees, and/or about 60 degrees.

The term “about” in this disclosure, when used to describe any numerical range or value, references a margin within ±5% of the stated value or range.

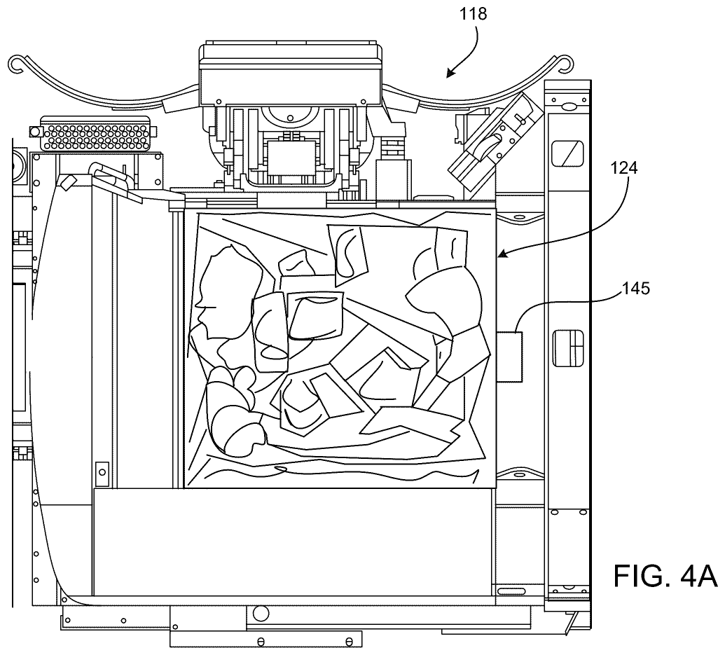

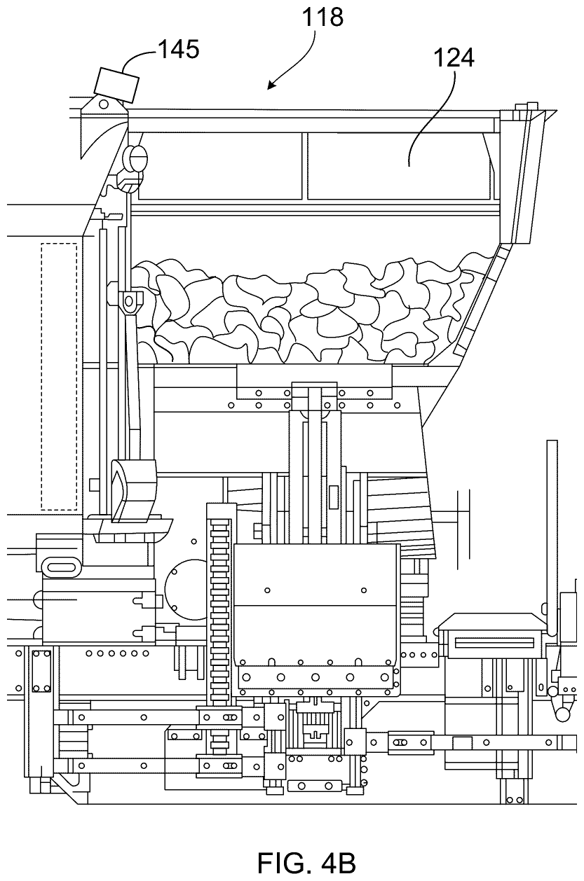

The hopper condition data output by intake sensor 145 reflects whether and/or to what extent the refuse intake volume of hopper 124 is filled with refuse (see FIG. 4A-4B) or cleared of refuse (see FIGS. 1-3). The type of hopper condition data output varies based on the type of sensor. Intake sensor 145 may take a variety of different forms. As one example, where intake sensor 145 takes the form of a camera (e.g., a one-, two-, or three-dimensional camera), the hopper condition data may include image data corresponding to a scene within the camera's field of view, such as one or more still images or moving-image video clips. As another example, where intake sensor 145 takes the form of a vision sensor (e.g., a camera with an integral data processor), the hopper condition data may include the result of one or more image processing operations, such as a flag, image classification, or object distance measurement. As yet another example, where intake sensor 145 takes the form of an object distance or proximity sensor (e.g., laser, ultrasonic, radar, LiDAR, infrared, etc.), the hopper condition data may include a measured time-of-flight, intensity, or phase change; a flag or classification; or a calculated distance.

In this example, packer 130 features an auger 142 and an auger drive 144. Auger 142 resides within hopper 124, extending through a channel in the hopper's floor 125a, and includes a cylindrical tube carrying a helicoid flight on its outer surface. Auger drive 144 is an electric drive including a prime mover in the form of an electric motor. Auger drive 144 rotates the tube of auger 142 about its longitudinal axis, causing the flight to move like a screw thread. Movement of the flight conveys any waste in the hopper 124 rearward, where it passes through an aperture in the ejector 132 and enters the enclosed volume of the storage container 120. As waste builds up in the storage container 120, rotation of the auger 142 not only transfers new waste from the hopper 124 into the storage container 120 but also pushes the new waste against the existing waste already in the storage container 120. Compacting the waste in this manner decreases its volume and increases the storage capacity of the storage container. Additional details and descriptions regarding packing and ejecting can be found in United States Publication No. 2021/0039880, the entirety of which is incorporated herein by reference.

A packer load sensor 152 monitors a load imparted on or by the packer 130 and outputs packer load data corresponding to the same. As one example, packer load sensor 152 may take the form of a torque measuring device (e.g., a rotary or reaction torque transducer, a load cell, etc.) that measures torque applied by a prime mover of auger drive 144 to another packer component (e.g., the tube of auger 142). As another example, packer load sensor 152 may take the form of a device that measures certain operating characteristics/qualities of the prime mover (e.g., a current or voltage measuring device). Packer load sensor 152 provides a stream of packer load data values. In this example, the data stream includes a plurality of packer load data values ranging between a lower limit (e.g., 0) and an upper limit (e.g., 1,000). Additionally, in this example, packer load sensor 152 outputs packer load data values according to a predetermined sample rate (e.g., 1 Hz, 10 Hz, or 100 Hz).

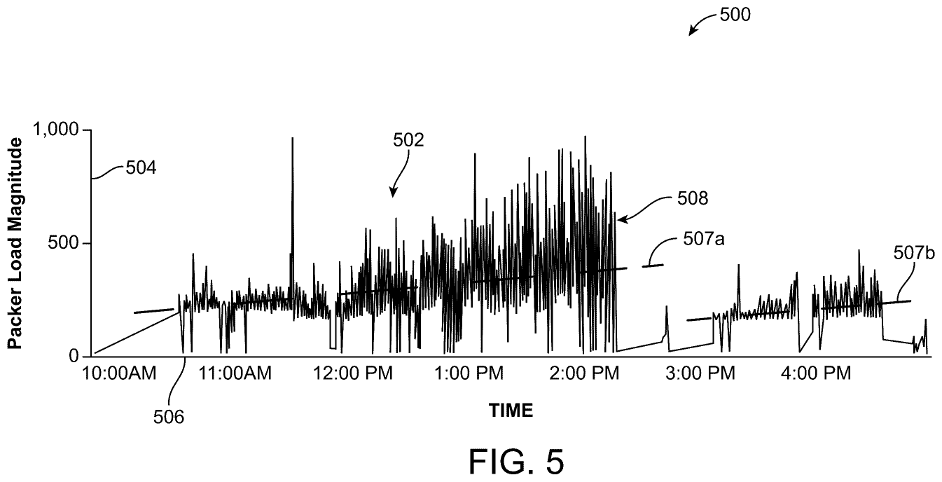

FIG. 5 is a plot 500 of a packer load data stream 502 during a refuse collection route traversed by vehicle 100. The vertical axis 504 represents the magnitude of the packer load data; and the horizontal axis 506 represents the passage of time. In this example, packer load data stream 502 includes a series of data points, each data point representing the maximum packer load data value received from packer load sensor 152 (see FIG. 3) during a packing cycle following a given dump-cycle service event.

Note that the magnitude of the packer load data stream 502 generally follows an increasing trendline 507a over time, as the vehicle 100 executes service events and collects waste in the storage container 120. The increasing trendline 507 indicates that, as the storage container 120 becomes increasingly full of waste, the packer 130 works harder to perform the compaction process. Accordingly, the trendline breaks (508) after an ejection event, which empties the storage container 120 and lessens the work of the packer 130. From there, as the vehicle conducts additional service events and collects more waste in storage container 120, a new increasing trendline 507b begins to form.

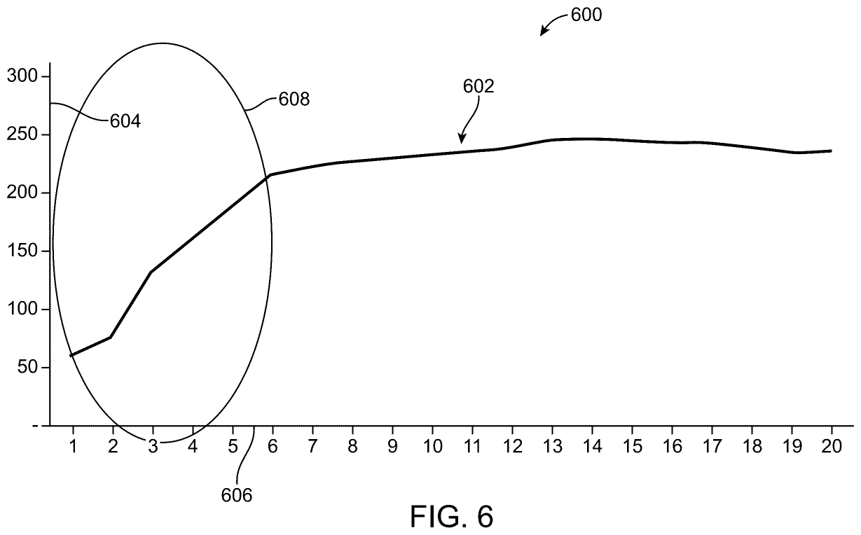

FIG. 6 is a plot 600 of a packer load data stream 602 associated with a packing cycle after a dump-cycle service event. The vertical axis 604 represents the magnitude of the packer load data; and the horizontal axis 606 represents the passage of time in seconds. In this example, packer load data stream 602 includes a series of data points, each data point representing a per-second average packer load data value. For example, if the sample rate of packer load sensor 152 is 10 Hz, the ten individual packer load data values produced each second by sensor 152 would be averaged, and the per-second average packer load data value would be included in data stream 602.

Note that the magnitude of the packer load data stream 602 increases during the initial “warm up” period 608 after a service event before reaching a substantially steady state. This warm-up period 608 indicates that it takes certain amount of time for the auger: (i) to come up to an operational level (e.g., speed) designated by the controller 150 and auger drive 144; and/or (ii) to start the work of packing waste deposited during the service event against the existing waste in the storage container. In some embodiments, the warm-up period 608 is between about 1-20 seconds, such as between about 2-15 seconds, between about 3-10 seconds, and/or about 5 seconds.

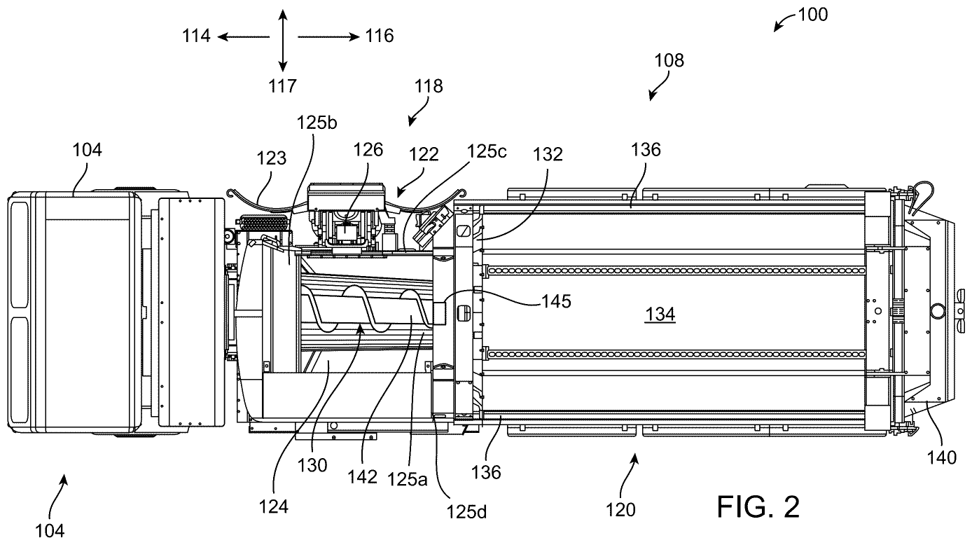

In one exemplary (but non-limiting) use-case, vehicle 100 traverses a refuse collection route including numerous (e.g., hundreds) of service stops to pick up residential refuse containers, dump waste into the hopper 124, transfer waste from the hopper 124 into the storage container 120, and compact the waste within the storage container 120. After completing all or a portion of a collection route, vehicle 100 travels to a designated area and ejects the waste from the storage container 120 using the ejector 132. To eject a load of waste, tailgate 140 pivots from a closed position (as shown in FIGS. 1-2) to an open position, and the panel of ejector 132 moves rearward, pushing the load through the tailgate opening (an “eject event”). A set of one or more ejector sensors 133 monitor operation of ejector 132 during such an ejection event.

Returning to FIG. 3, controller 150 controls the operation of packer 130. Accordingly, controller 150 is communicatively coupled with auger drive 144, intake sensor 145, and packer load sensor 152 via an information network 154.

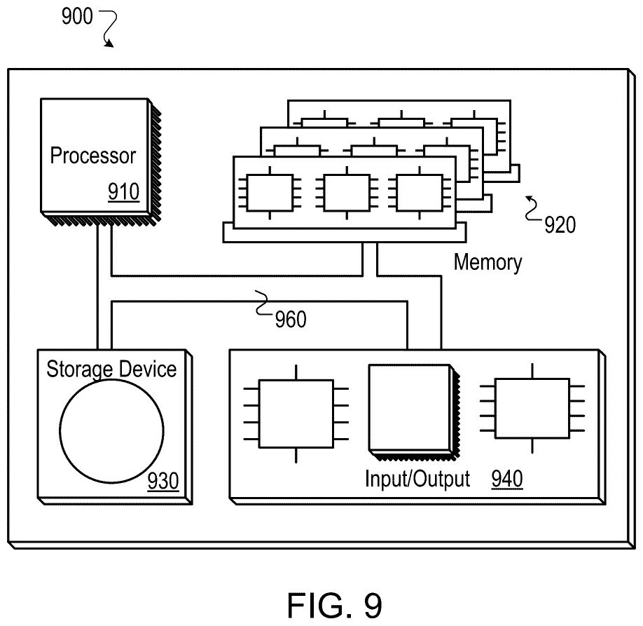

In this example, controller 150 is an under-dash device (UDU) and may also be referred to as the Gateway. Controller 150 includes a programmable logic controller (PLC) with integral data input/output, memory, and processing components (see, e.g., FIG. 9). Information network 154 includes an onboard wired data bus. Controller 150 issues command signals through the information network 154 that cause auger drive 144 to rotate auger 142. The command signals from controller 150 may dictate the direction and speed of rotation. The command signals may also cause auger drive 144 to cease rotating auger 142.

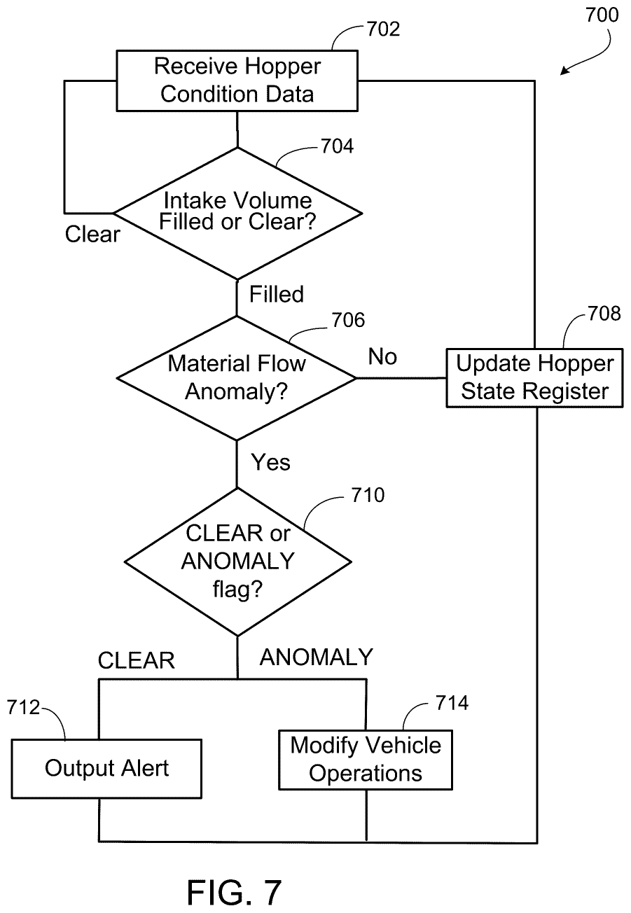

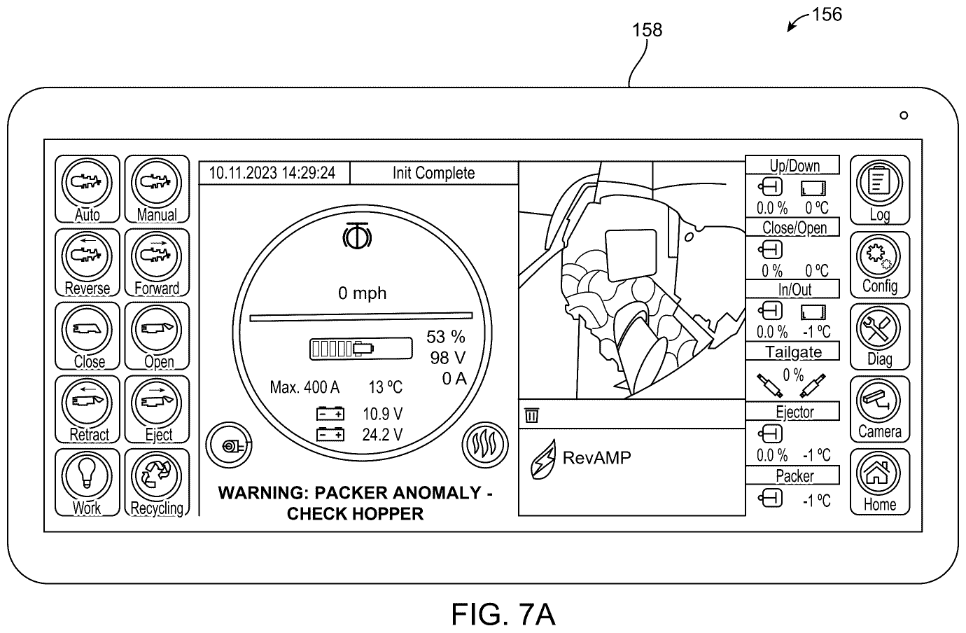

Controller 150 performs control schemes and issues auger-control commands based on hopper condition data and/or packer load data received, via information network 154, from intake sensor 145 and/or packer load sensor 152, respectively (see FIG. 7). Controller 150 also provides, via information network 154, information (e.g., data, alerts, etc.) regarding the operation of refuse collecting body 108 to a user interface system 156 viewable by a human operator in the vehicle's cab 104 (see FIG. 7A).

The inventor(s) associated with this disclosure have discovered a number of ways to utilize hopper condition data, optionally in conjunction with packer load data, to reliably and accurately detect different states of a refuse collecting body, including (but not necessarily limited to) states where a material flow anomaly is affecting the ability of auger 142 (packer 130) to transfer refuse from hopper 124 to storage container 120. One exemplary (but non-limiting) type of material flow anomaly called “bridging” occurs when a mass of refuse forms a bridge or arch over the flight of the rotating auger. The bridge prevents or inhibits other pieces of refuse from reaching the flight and being conveyed through the auger. When bridging occurs on the body of a refuse collection vehicle during a route, the auger does not transfer waste from the hopper to the storage container effectively, causing refuse to build up in the hopper over multiple service events. If the service events continue and the bridge is not cleared in time, refuse may begin to escape from the overfilled hopper.

FIG. 7 is a flowchart of a process 700 that includes detecting a material flow anomaly affecting a packer (e.g., packer 130/auger142) on a refuse collection vehicle (e.g., vehicle 100). In some embodiments, process 700 may be one of the control schemes performed by one or more onboard computer processing devices (e.g., controller 150). In some embodiments, process 700 may be performed by a remote computer based on data collected by sensors onboard the refuse collection vehicle. In some embodiments, the onboard controller performs one or more steps of process 700 and the remote computer performs one or more other steps of process 700.

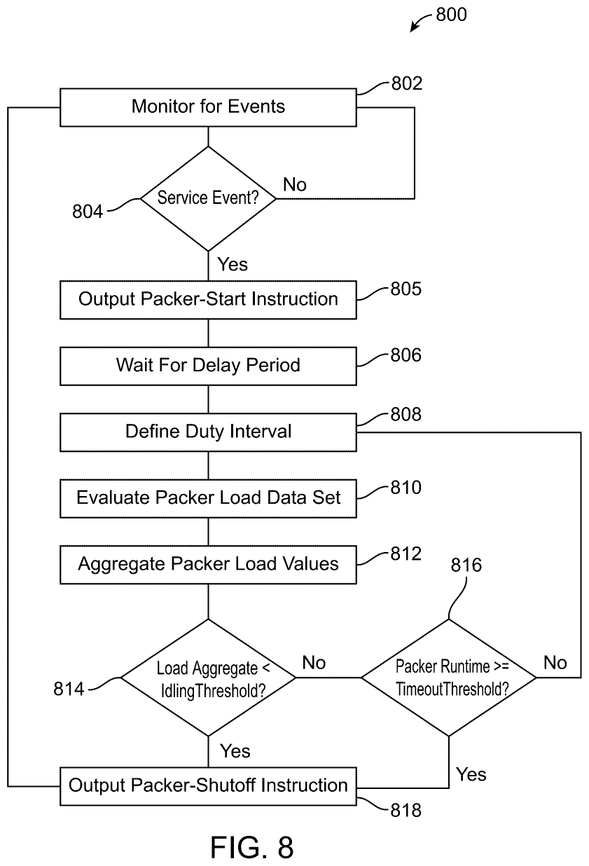

Step 702 includes receiving hopper condition data from an intake sensor (e.g., intake sensor 145). As discussed, depending on the type of intake sensor, the hopper condition data may include image data (e.g., still images or moving-image video clips), a flag, a classification, a distance measurement, a measured time-of-flight, etc. In some examples, the hopper condition data is received from intake sensor 145 continuously or at predetermined time intervals (e.g., every 5 minutes). In some examples, the receipt of hopper condition data from intake sensor 145 is triggered by an event—e.g., after every service event, after multiple service events, after an auger shut-down event, or after an auger idling event (see FIG. 8).

Step 704 includes determining, based on the received hopper condition data, a fill-state condition of a refuse intake volume (e.g., the volume of hopper 124). In some implementations, where intake sensor 145 is a camera outputting hopper condition data in the form of moving or still images, controller 150 includes an image classifier that analyzes pixels of the image data to determine the fill-state condition of the hopper's refuse intake volume. In some examples, the camera (intake sensor 145) has a detection direction 146 that places at least a portion of auger 142 within the scene of the camera's field of view when the refuse intake volume is in a clear state containing little to no refuse. When, by contrast, the refuse intake volume is in a filled state, auger 142 is at least partially covered by the refuse and obscured or completely hidden from view in the scene. Accordingly, controller 150 can receive image data from the camera (intake sensor 145) and employ the image classifier to perform a pixel analysis that discerns whether the captured scene includes auger 142. In some examples, the image classifier provides an indication of whether auger 142 is visible or not visible as a binary output and/or as a scaled confidence score (e.g. a score within the range of 1%-100%). Controller 150 determines the fill-state condition of the refuse intake volume—e.g., clear, filled, or partially filled-based on output from the image classifier regarding the visibility of auger 142.

In some examples, the pixel analysis discerns the visibility of auger 142 within the captured scene based on neighboring or nearby pixels that share a predetermined color, hue, saturation, and/or intensity characteristic associated with auger 142 (e.g., black pixels if the auger is painted black). In some examples, the pixel analysis discerns the visibility of auger 142 by identifying a contrast between pixel characteristics associated auger 142 and pixel characteristics associated with hopper 124 (e.g., the contrast between a white hopper and a black auger). In some examples, the pixel analysis involves identifying one or more visual indicia placed on auger 142 (e.g., a line, shape, symbol, logo, code, serial number, stamp, etc.). In some examples, the pixel analysis involves one or more object detection and recognition routines that use a model to detect the visibility of auger 142 with or without added indicia (e.g., identifying the auger by detecting an object having a certain shape or size).

The image classifier of controller 150 may include or be implemented using one or more artificial intelligence models—e.g., unsupervised learning models, supervised learning models, deep learning models, regression models, fuzzy logic models, decision trees, and/or neural networks. The artificial intelligence models can be trained based on a training dataset. The training dataset may include several images (e.g., tens, hundreds, or thousands of images) depicting scenes of a refuse intake volume. In some examples, the training dataset includes images where the refuse intake volume is clear and the auger is visible in the scene. In some examples, the training dataset includes images where the refuse intake volume is at least partially or completely full, such that refuse partially or completely covers the auger and the auger is only partially visible or not visible at all. In some examples, images in the training dataset of have different hue, saturation, contrast, blur, and/or intensity levels. In some examples, images in the training dataset are tagged to indicate whether the auger is visible, partially visible, and or not visible (i.e., covered by refuse).

In some implementations, the training dataset includes images generated during refuse collection routes and flagged or tagged by vehicle operators. Accordingly, the artificial intelligence models can be updated or retrained as new training data is obtained over time. For example, the image classifier model may be retrained after the vehicle completes a predetermined number of refuse collection routes (e.g., retrain after 5, 10, or 20 ejection events, retrain at vehicle startup, etc.). By updating and retraining the model, the image classifier can adapt to changes in the appearance of the auger and/or hopper (e.g., dirt/waste accumulation, staining, chipped or peeling paint, dents, etc.), both of which are subject to a harsh operating environment that may change their visual appearance.

Additionally, just as the above-described examples involve pixel analyses and artificial intelligence models that discern the visibility of auger 142, some examples may additionally or alternatively focus on discerning the visibility of hopper 124, such as the hopper's floor 125a or an area of the hopper's walls 125b, 125c, 125c. Like the auger, the shape, surface, color, identifying marks, etc. of the hopper are distinguishable from refuse, such that the visibility of the hopper within the scene of a captured image can indicate whether and/or to what degree the hopper is filled with or clear of refuse. In some implementations, for example, controller 150 determines that the refuse intake volume is clear of refuse when output from the image classifier indicates visibility of the hopper floor.

Further still, while the above-described examples involve pixel analyses and artificial intelligence models that discern the visibility of auger 142 or hopper 124, some examples may additionally or alternatively discern the visibility of refuse. For example, controller 150 may employ an image classifier to determine that refuse is present throughout (or substantially throughout) the scene captured by the image data, an indication that the hopper's refuse intake volume is at least partially filled with refuse.

The examples described above where intake sensor 145 includes a camera that outputs image data to controller 150 can be similarly implemented using a vision sensor with internal image processing components. That is, the internal image processing components of the vision sensor may include an image classifier and perform pixel analyses to discern the visibility of auger 142, hopper 124, and/or refuse within the hopper's refuse intake volume. Here, as before, controller 150 determines the fill-state condition of the refuse intake volume—e.g., clear, filled, or partially filled-based on output from the image classifier.

Still referencing step 704, in some implementations, intake sensor 145 is an object distance sensor (e.g., laser, ultrasonic, radar, LiDAR, infrared, etc.) outputting hopper condition data that includes a measured distance value or information (e.g., a measured time-of-flight) from which controller 150 can calculate a distance value. The measured or calculated distance value represents the distance between intake sensor 145 and the nearest object within the sensor's line of sight. Accordingly, controller 150 determines a fill-state condition of the hopper's refuse intake volume by comparing a measured or calculated distance value to a predetermined threshold. In some examples, the threshold corresponds to the hopper floor distance, i.e., the total straight-line distance from intake sensor 145 to the floor 125a of hopper 124. The threshold, for instance, may be set to about 20%-100% of the floor distance, about 40%-90% of the floor distance, about 50%-70% of the floor distance, or about 60% of the floor distance. If the measured or calculated distance value is less than the predetermined threshold, controller 150 determines that the refuse intake volume is filled. If the measured or calculated distance value is greater than the predetermined threshold, controller 150 determines that the refuse intake volume is clear.

In implementations where intake sensor 145 is an object proximity sensor, the detection range of the sensor may correspond to the hopper floor distance (e.g., about 20%-100% of the floor distance, about 40%-90% of the floor distance, about 50%-70% of the floor distance, or about 60% of the floor distance). Accordingly, at step 704, controller 150 determines that the refuse intake volume is filled in response to receiving a yes/true/on binary output from the proximity sensor; and controller 150 determines that the refuse intake volume is clear in response to receiving a no/false/off binary output from the proximity sensor.

If the fill-state condition determined at step 704 is clear, indicating that the refuse intake volume contains little to no refuse, the process returns to step 702 and continues monitoring the received hopper condition data. If the fill-state condition determined at step 704 is filled or partially filled, the process 700 proceeds to step 706.

Step 706 includes using the fill-state condition of the refuse intake volume to determine whether a material flow anomaly is affecting the packer. In some implementations, controller 150 makes the material-flow-anomaly determination at step 706 based on a triggering event. In some examples, the triggering event is the determination by controller 150 that the fill-state condition of the refuse intake volume is filled (per step 704). In these examples, controller 150 automatically determinates that there is a material flow anomaly when the refuse intake volume is filled or at least partially filled with refuse. In some examples, the triggering event corresponds to an indication that the fill level of the refuse intake volume is abnormally high. As just one non-limiting example, the triggering event may include a measured or calculated distance value from an object distance senor that is less than a predetermined threshold (e.g., about 10% of the floor distance).

In some implementations, controller 150 makes the material-flow-anomaly determination at step 706 based on one or more time-based or event-based conditions. In some examples, controller 150 determines that there is a material flow anomaly when the refuse intake volume has been filled (per step 704) for more than a certain amount of time (e.g., more than 5 minutes) or a certain number of service events (e.g., more than 10 service events). The time and/or event thresholds may be updated (e.g., incrementally increased or decreased) during a collection route.

In some implementations, controller 150 makes the material-flow-anomaly determination at step 706 based on the state of auger 142. In some examples, controller 150 determines that there is a material flow anomaly when the refuse intake volume is filled (per step 704) and the auger has been shut down (see FIG. 8). In some examples, controller 150 determines that there is a material flow anomaly when the indication that refuse intake volume is filled (per step 704) coincides with a sustained decrease in packer load (e.g., a decrease of at least 20% in the rolling average of packer load data values sustained for at least 5 seconds, or 10 consecutive packer load data values that are 20% below the current trend line, see FIG. 5). In some examples, controller 150 determines that there is a material flow anomaly when the indication that the refuse intake volume is filled (per step 704) coincides with a determination that auger 142 is idling, as described below with reference to FIG. 8.

If the determination at step 706 indicates that there is no material flow anomaly, the process 700 proceeds to step 708 and updates the hopper state register, a computer storage location that holds the current state of the hopper's refuse intake volume. For example, step 708 may include adding a CLEAR flag to the register, removing an ANOMALY flag from the register, etc. After updating the hopper state register at step 708, the process returns to step 702 and continues monitoring the received hopper condition data. If the determination at step 706 indicates that there is a material flow anomaly, the process 700 proceeds to step 710, which includes accessing the hopper state register.

If, at step 710, the hopper state register contains a CLEAR flag, indicating the absence of a material flow anomaly in the previous iteration, process 700 proceeds to step 712. Step 712 involves outputting an alert. For example, the controller 150 may generate a command signal for the user interface system 156 to produce a visual and/or audible alert sufficient to notify the vehicle operator of the detected material flow anomaly. FIG. 7A depicts a non-limiting example of a visual alert displayed on a graphical display 158 of the user interface system 156. The alert, whether visual or audible, may include qualitative information (e.g., a general warning) and/or quantitative information (e.g., a numerical degree) regarding the fullness level of the refuse intake volume. In addition to outputting an alert, step 712 may further include presenting a live image of hopper 124 on graphical display 158 for visual inspection by the operator. After outputting the alert, the process 700 proceeds to step 708 and updates the hopper state register, e.g., by adding an ANOMALY flag to the register, removing a CLEAR flag from the register, etc.

If, at step 710 the hopper state register contains an ANOMALY flag, indicating the detection of a material flow anomaly in the previous iteration that remains unresolved, process 700 proceeds to step 714. Step 714 involves modifying the operations of the refuse collection vehicle to resolve and/or mitigate the results of the material flow anomaly. In some examples, step 714 includes the controller 150 outputting command signals that cause auger 142 to perform a de-bridging routine. The de-bridging routine may include reversing the auger's direction of rotation, modifying the speed or torque, etc. In some examples, step 714 includes the controller 150 outputting a lockout instruction. For instance, the lockout instruction may include an override command that inhibits certain operative movements of the lift 122 and prevents additional service events.

FIG. 8 is a flowchart of a process 800 that includes determining, based on packer load data, that a packer (e.g., packer 130) on a refuse collection vehicle (e.g., vehicle 100) is operating in an idle state, as discussed above regarding step 706 of FIG. 7. The packer may be operating in an idle state when the auger (e.g., auger 142) is being driven to rotate by a drive unit (e.g., auger drive 144) but is not performing useful packing work. During normal operations such an idle state may occur when the vehicle's storage container (e.g., storage container 120) does not contain enough existing waste for the new waste from the most recent service event to be compacted against. An idle state may also occur when a material flow anomaly, such as bridging, prevents the auger from moving reuse from the hopper (e.g., hopper 124) to the storage container.

In some embodiments, process 800 may be one of the control schemes performed by an onboard controller (e.g., controller 150). In some embodiments, process 800 may be performed by a remote computer based on data collected by sensors onboard the refuse collection vehicle. In some embodiments, the onboard controller performs one or more steps of process 800 and the remote computer performs one or more other steps of process 800.

Steps 802 and 804 includes monitoring for service events. In this example, as discussed, a service event includes a dump cycle, where the refuse vehicle's lift (e.g., lift 122) performs a sequence of operations to deposit waste from a refuse container into the hopper (e.g., hopper 124). Additionally, in this example, monitoring for service events includes receiving and processing sensor data corresponding to operation of the lift (e.g., data produced by lift sensor(s) 129).

Following a service event, the process 800 includes outputting an instruction to begin operation of the packer (step 805) and waiting for a delay period (step 806) while the packer is operating. In some embodiments, the delay period corresponds to the warm-up period of the auger. In some embodiments, the delay period is between about 1-30 seconds after the service event, such as between about 5-20 seconds after the service event, between about 7-15 seconds after the service event, and/or about 10 seconds after the service event.

Following the delay period, the process includes defining a duty interval (step 808). In this example, the duty interval includes a time segment of a predetermined duration. In some embodiments the duration is between about 0.1-5 seconds, such as between about 0.2-3 seconds, between about 0.5-2 seconds, and/or about 1 second. Initially, the duty interval (DI₀) is the time segment immediately after the delay period. For future iterations (n), the duty interval (DIₙ) is the time segment immediately after the prior time segment of the prior duty interval (DIₙ₋₁).

Process 800 further includes evaluating a packer load data set (step 810). The packer load data set includes the data stream output by a packer load sensor (e.g., packer load sensor 152) during the time segment of the duty interval. In this example, evaluating the packer load data includes averaging the individual packer load data values within the data stream of the duty interval.

Process 800 further includes aggregating multiple averaged packer load data values (step 812). In this example, the aggregation includes incorporating the averaged packer load data value for the current duty interval into a rolling total of averaged packer load data values from multiple duty intervals. In some embodiments, the rolling total includes between about 2-20 average packer load data values, such as between about 2-15 average packer load data values, between about 3-12 average packer load data values, and/or about 5 average packer load data values, and/or about 4 average packer load data values, and/or about 3 average packer load data values.

Process 800 further includes comparing the aggregate packer load value to an idling threshold value (step 814). In a particular example, this idling threshold value is derived empirically from a statistical analysis of historical packer load data streams collected during prior refuse collecting routes. The idling threshold value is then input and stored in the onboard controller and/or remote computer for executing the process 800.

In a particular example, this idling threshold value is derived empirically from a statistical analysis of historical packer load data streams collected during prior refuse collecting routes. The idling threshold value is then input and stored in the onboard controller and/or remote computer for executing the process 800. In some embodiments, the idling threshold can be defined as a multiple of the upper limit of the packer load data values. In some embodiments, the multiplying factor is between about 0.01-1.00, such as between about 0.05-0.80, between about 0.10-0.50, about 0.20, about 0.16, about 0.12, about 0.10, and/or about 0.08. In a particular implementation, the upper limit of the packer load data values is 1,000 and the multiplying factor of the threshold is about 0.12. Thus, the idling threshold is about 120.

According to comparison step 814, if the aggregate packer load value is not less than the idling threshold value, the process 800 determines, at step 816, whether the packer runtime—that is, the amount of time the packer has been operating after the service event—is greater than or equal to a predetermined timeout threshold (e.g., about 25-30 seconds). If the packer runtime is not greater than or equal to the timeout threshold, the process 800 returns to execute a subsequent iteration of steps 808-814. If the packer runtime is greater than or equal to the timeout threshold, the process 800 outputs an instruction to shut off the packer (step 818). Additionally, per step 814, if the packer load value is less than the idling threshold value, the process outputs the packer-shutoff instruction (step 818).

The controllers, control units and/or computing devices described throughout this disclosure can include or employ one or more computing systems. FIG. 9 depicts an example computing system 900. The system 900 may be used for any of the operations or functions described in this disclosure with reference to a computing device. For example, the system 900 may be included, at least in part, in controller 150 and/or any other computing device(s) or system(s) associated with the refuse collection vehicle 100. The system 900 includes one or more processors 910, a memory 920, one or more storage devices 930, and one or more input/output (I/O) devices controllable via one or more I/O interfaces 940. The various components 910, 920, 930, or 940 may be interconnected via at least one system bus 960, which may enable the transfer of data between the various modules and components of the system 900.

The system bus 960 may include a series of wired or wireless connections. In some embodiments, the system bus includes a CAN network bus operating under the J1939 protocol.

The processor(s) 910 may be configured to process instructions for execution within the system 900. The processor(s) 910 may include single-threaded processor(s), multi-threaded processor(s), or both. The processor(s) 910 may be configured to process instructions stored in the memory 920 or on the storage device(s) 930. For example, the processor(s) 910 may execute instructions for the various software module(s) described herein. The processor(s) 910 may include hardware-based processor(s) each including one or more cores. The processor(s) 910 may include general purpose processor(s), special purpose processor(s), or both.

The memory 920 may store information within the system 900. In some embodiments, the memory 920 includes one or more computer-readable media. The memory 920 may include any number of volatile memory units, any number of non-volatile memory units, or both volatile and non-volatile memory units. The memory 920 may include read-only memory, random access memory, or both. In some examples, the memory 920 may be employed as active or physical memory by one or more executing software modules.

The storage device(s) 930 may be configured to provide (e.g., persistent) mass storage for the system 900. In some embodiments, the storage device(s) 930 may include one or more computer-readable media. For example, the storage device(s) 930 may include a floppy disk device, a hard disk device, an optical disk device, or a tape device. The storage device(s) 930 may include read-only memory, random access memory, or both. The storage device(s) 930 may include one or more of an internal hard drive, an external hard drive, or a removable drive.

One or both of the memory 920 or the storage device(s) 930 may include one or more computer-readable storage media (CRSM). The CRSM may include one or more of an electronic storage medium, a magnetic storage medium, an optical storage medium, a magneto-optical storage medium, a quantum storage medium, a mechanical computer storage medium, and so forth. The CRSM may provide storage of computer-readable instructions describing data structures, processes, applications, programs, other modules, or other data for the operation of the system 900. In some embodiments, the CRSM may include a data store that provides storage of computer-readable instructions or other information in a non-transitory format. The CRSM may be incorporated into the system 900 or may be external with respect to the system 900. The CRSM may include read-only memory, random access memory, or both. One or more CRSM suitable for tangibly embodying computer program instructions and data may include any type of non-volatile memory, including but not limited to: semiconductor memory devices, such as EPROM, EEPROM, DRAM, and flash memory devices; magnetic disks such as internal hard disks and removable disks; magneto-optical disks; and CD-ROM and DVD-ROM disks. In some examples, the processor(s) 910 and the memory 920 may be supplemented by, or incorporated into, one or more application-specific integrated circuits (ASICs).

The system 900 may include one or more I/O devices (not shown). The I/O device(s) may include one or more input devices such as a joystick, keypad, keyboard, a mouse, a pen, a game controller, a touch input device (e.g., a touch pad), an audio input device (e.g., a microphone), a gestural input device, a haptic input device, an image or video capture device (e.g., a camera), a mobile device, or other devices. In some examples, the I/O device(s) may also include one or more output devices such as a display, LED(s), an audio output device (e.g., a speaker), a printer, a haptic output device, and so forth. The I/O device(s) may be physically incorporated in one or more computing devices of the system 900, or may be external with respect to one or more computing devices of the system 900.

The system 900 may include one or more I/O interfaces 940 to enable components or modules of the system 900 to control, interface with, or otherwise communicate with the I/O device(s). The I/O interface(s) 940 may enable information to be transferred in or out of the system 900, or between components of the system 900, through serial communication, parallel communication, or other types of communication. For example, the I/O interface(s) 940 may comply with a version of the RS-232 standard for serial ports, or with a version of the IEEE 1284 standard for parallel ports. As another example, the I/O interface(s) 940 may be configured to provide a connection over Universal Serial Bus (USB) or Ethernet. In some examples, the I/O interface(s) 940 may be configured to provide a serial connection that is compliant with a version of the IEEE 1394 standard.

The I/O interface(s) 940 may also include one or more network interfaces that enable communications between computing devices in the system 900, or between the system 900 and other network-connected computing systems. The network interface(s) may include one or more network interface controllers (NICs) or other types of transceiver devices configured to send and receive communications over one or more communication networks using any network protocol.

Computing devices of the system 900 may communicate with one another, or with other computing devices, using one or more communication networks. Such communication networks may include public networks such as the internet, private networks such as an institutional or personal intranet, or any combination of private and public networks. The communication networks may include any type of wired or wireless network, including but not limited to local area networks (LANs), wide area networks (WANs), wireless WANs (WWANs), wireless LANs (WLANs), mobile communications networks (e.g., 3G, 4G, Edge, etc.), and so forth. In some embodiments, the communications between computing devices may be encrypted or otherwise secured. For example, communications may employ one or more public or private cryptographic keys, ciphers, digital certificates, or other credentials supported by a security protocol, such as any version of the Secure Sockets Layer (SSL) or the Transport Layer Security (TLS) protocol.

The system 900 may include any number of computing devices of any type. The computing device(s) may include, but are not limited to: a personal computer, a smartphone, a tablet computer, a wearable computer, an implanted computer, a mobile gaming device, an electronic book reader, an automotive computer, a desktop computer, a laptop computer, a notebook computer, a game console, a home entertainment device, a network computer, a server computer, a mainframe computer, a distributed computing device (e.g., a cloud computing device), a microcomputer, a system on a chip (SoC), a system in a package (SiP), and so forth. Although examples herein may describe computing device(s) as physical device(s), embodiments are not so limited. In some examples, a computing device may include one or more of a virtual computing environment, a hypervisor, an emulation, or a virtual machine executing on one or more physical computing devices. In some examples, two or more computing devices may include a cluster, cloud, farm, or other grouping of multiple devices that coordinate operations to provide load balancing, failover support, parallel processing capabilities, shared storage resources, shared networking capabilities, or other aspects.

While this specification contains many specifics, these should not be construed as limitations on the scope of the disclosure or of what may be claimed, but rather as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some examples be excised from the combination, and the claimed combination may be directed to a sub-combination or variation of a sub-combination.

A number of embodiments have been described. Nevertheless, it will be understood that various modifications may be made without departing from the spirit and scope of the disclosure. Accordingly, other embodiments are within the scope of the following claim(s).

For example, although the vehicle described above is a refuse collection vehicle referred to as “garbage truck” that collects refuse or garbage, in some embodiments, such a vehicle is designed to collect a variety of different types of used or discarded refuse materials—e.g., recyclables, hazardous materials, construction materials, etc.

As another example, although the cab of the refuse vehicle is described above as featuring a compartment for a human driver, in some embodiments, the refuse vehicle can be operated autonomously or semi-autonomously, or a combination thereof.

As yet another example, some embodiments of this disclosure can be implemented without a mobile vehicle chassis. For instance, the storage container and packer can be fixed in place on a ground surface.

As yet another example, although the refuse vehicle is described above as having side-loading lift, in some embodiments, the refuse vehicle may have a front-loading lift, and/or a rear-loading lift, or no lift at all.

As yet another example, although the service event described above includes certain specific operations of an automated dump cycle, the concept of a “service event” is more broadly understood and used in this disclosure. For instance, in some embodiments, a service event may include a dump cycle including different operations or the same operations performed in a different order (or simultaneously). Additionally, in some embodiments, a service event may include some other manner of depositing waste (or other materials) onto the vehicle. For instance, a service event may include a human worker (or customer) placing the waste into a receptacle of the vehicle.

As yet another example, although the packer described above features an auger-style compactor, in some embodiments, the packer may include a translating packer blade.

As yet another example, although the auger drive described above is an electric drive featuring an electric motor, in some embodiments, the auger drive can take a variety of different forms. For instance, the auger drive may include a hydraulic, pneumatic, or a combustion-based prime mover. Moreover, in some examples, the auger drive may further include various transmission elements (e.g., gearing) to transmit power from the prime mover to the auger (or packer blade).

As yet another example, an addition to the above-described sensors for monitoring the lift, packer, and ejector, the refuse vehicle may further include sensors for monitoring a variety of other components, operations, and/or the vehicle's surrounding environment. Such sensors may take a variety of forms. For example, the sensors can include, but are not limited to, an analog sensor, a digital sensor, a CAN bus sensor, a magnetostrictive sensor, a radio detection and ranging (RADAR) sensor, a light detection and ranging (LiDAR) sensor, a laser sensor, an ultrasonic sensor, an infrared (IR) sensor, a stereo camera, a three-dimensional (3D) camera, or a combination thereof.

As yet another example, the communicative coupling between the above-described logical controller (e.g., controller 150) and the auger/packer drive may take a variety of forms. For instance, in some embodiments, the logical controller provides command instructions to the drive, and those instructions trigger the drive to regulate operation of the auger (packer). Alternatively, in some embodiments, the logical controller provides command instructions to an energy source or intermediate controller—e.g., a battery pack, a converter (battery controller), or a hydraulic pump or valve)—that powers and regulates the drive.

As yet another example, although the logical controller (e.g., controller 150) is described above as issuing control instructions/commands based on determinations that stem from hopper condition data and/or packer load data, in some embodiments, the controller may be operable to issue such instructions/commands in response to user input and/or requests from a remote computing device.

As yet another example, in some embodiments, the above-described refuse collection vehicle is an all-electric vehicle or an at least partially electric vehicle. For instance, one or more (e.g., all) motive power elements, body controls, and sub-systems of the refuse collection vehicle can be electrically powered by onboard battery packs.

As yet another example, although the information network is described above as an onboard wired data bus, in some embodiments, the network may take the form of a wireless network.

As yet another example, in some embodiments, the above-described intake sensor includes an array of multiple sensors. In some embodiments, the intake sensor array may include multiple different types of sensors. In some embodiments, different sensors in the sensory array are mounted in different locations with unique detection directions for monitoring different portions of the refuse intake volume.

As yet another example, although the above-described intake sensor is a contactless sensor, in some embodiments, the intake sensor may include a plumb bob, rack, arm, or cover designed to make contact with refuse in the intake volume, the auger/packer, and/or a portion of the hopper.

As yet another example, although the above-described intake sensor is mounted above the refuse intake volume, in some embodiments, the intake sensor is mounted or embedded within or below the hopper.

As yet another example, some embodiments may include a sensor emitter on, within, or beneath the hopper, with the intake sensor being configured to detect a signal from the emitter to determine a fill-state condition.

As yet another example, in some embodiments, the intake sensor further includes a shield or guard to provide protection against impact from refuse deposited in the intake volume. Additionally, in some embodiments, the intake sensor further includes an automatic cleaning device.

As yet another example, although the logical controller (e.g., controller 150) is described and illustrated above as operating the auger/packer, in some embodiments, the logical controller may be integrated with one or more other onboard computing devices that control different assemblies or systems of the vehicle chassis or refuse collecting body (e.g., the ejector, lift, tailgate, etc.). As yet another example, although the logical controller is described and illustrated above as an onboard component, in some embodiments, the controller may be implemented such that one or more of its processing or storage components resides at a remote location.

As yet another example, although the above-described examples involve calculating distance values and using calculated object distance values to make certain determinations, in some embodiments the corresponding direct measurements (e.g., time-of-flight) from intake sensor 145 are used to make similar determinations.

As yet another example, in some embodiments, the above-described techniques and processes include discerning different levels of refuse intake volume fullness and making anomaly determinations by monitoring the fullness levels over time. For instance, an anomaly affecting the packer may be determined when the fullness level of the refuse intake volume is steadily increasing over time.

As yet another example, some embodiments may further include associating the detection of an anomaly affecting the packer with a particular service event and/or location. In such instances, the refuse collection vehicle can include location sensor device(s), such as GPS receivers or other types of sensors that enable location determination. The location sensor(s) can generate location data that describes a current location of the vehicle. Accordingly, when a material flow anomaly is detected, it can be associated and logged with the current location of the vehicle at that time. Doing so facilitates the ability to determine which customer service event may have been the source of the anomaly.

As yet another example, in some embodiments, the packer load data may include the integrated, aggregated, or otherwise combined output of multiple different sensors monitoring various aspects of the packer. As yet another example, in some embodiments, the packer load data output by the one or more sensors may include raw measured data and/or data pre-processed by the senor(s). As yet another example, in some embodiments, data output from the one or more sensor(s) may be triggered by the occurrence of an event (e.g., activation of the auger/packer), occur at predetermined time intervals, and/or occur in response to a received request (e.g., from the logical controller).

As yet another example, although the above-discussed embodiments describe evaluating a packer load data set corresponding to a given duty interval in terms of calculating an average data value, in some embodiments, the evaluation process includes identifying a maximum value, identifying a minimum value, identifying a certain percentile value (e.g., 5th percentile, the 10th percentile, the 90th percentile, the 95% percentile), or taking a mean/median/mode within the data set.

As yet another example, although the above-discussed embodiments describe aggregating packer load data values from multiple duty intervals in terms of calculating a rolling sum, in some embodiments, the aggregating process includes calculating a rolling mean/median/mode and/or performing other known data processing techniques. For instance, the aggregating process may include clustering operations—e.g., identifying a certain number of consecutive values above or below a given threshold.

As yet another example, although the above-discussed embodiments describe comparing aggregate packer load data values from multiple duty intervals to empirically-derived static thresholds, in some embodiments, the thresholds are dynamically derived or adjusted over time (e.g., during a refuse collection route or between routes). Additionally, in some embodiments, the thresholds are determined using heuristic and/or machine learning, and/or artificial intelligence techniques.

1. A refuse collection vehicle, comprising:
a vehicle chassis defining a forward and rearward direction of travel;
a refuse body on the vehicle chassis, the refuse body comprising:
a hopper providing a refuse intake volume;
a storage container rearward of the hopper, the storage container providing a refuse storage volume; and
a packer configured to transfer refuse from the intake volume of the hopper into the storage volume of the storage container and to pack waste within the storage volume;
an intake sensor configured to monitor the refuse intake volume of the hopper; and
a controller configured to determine based on data received from the intake sensor that a condition of the refuse intake volume indicates a material flow anomaly affecting the packer.

2. The refuse collection vehicle of claim 1, wherein the intake sensor comprises a contactless sensor oriented in a detection direction toward the refuse intake volume.

3. The refuse collection vehicle of claim 2, wherein the contactless sensor comprises at least one of a camera, a vision sensor, an object distance sensor, or an object detection sensor.

4. The refuse collection vehicle of claim 1, wherein the controller is further configured to adapt operations of the packer in response to detecting a material flow anomaly.

5. The refuse collection vehicle of claim 1, wherein the controller is further configured to trigger a visible or audible alert in response to detecting a material flow anomaly.

6. The refuse collection vehicle of claim 1, further comprising a packer load sensor configured to monitor a load applied to or by the packer, and wherein the controller is further configured to determine whether packer load data indicates a material flow anomaly affecting the packer.

7. The refuse collection vehicle of claim 6, wherein the packer comprises an auger, and wherein the load comprises a torque associated with the auger.

8. The refuse collection vehicle of claim 1, wherein the data received from the intake sensor comprises image data, and wherein the controller is configured to determine the condition of the refuse intake volume by performing a pixel analysis on the image data.

9. The refuse collection vehicle of claim 8, wherein the pixel analysis comprises an image classification based on a model trained to identify a visible signature of at least one of the auger or the hopper.

10. The refuse collection vehicle of claim 1, wherein the data received from the intake sensor comprises distance data, and wherein the controller is configured to determine the condition of the refuse intake volume by comparing the distance data to a predetermined threshold.

11. A method comprising:
receiving, by at least one processor, data generated by an intake sensor that is configured to monitor a refuse intake volume of a hopper of a refuse vehicle; and
detecting, by the at least one processor and based on the data, a material flow anomaly affecting a packer of the refuse collection vehicle, the packer being configured to transfer refuse from the intake volume of the hopper into a storage volume of a storage container.

12. The method of claim 11, wherein receiving the data generated by the intake sensor comprises receiving the data generated by a contactless sensor oriented in a detection direction toward the refuse intake volume.

13. The method of claim 12, wherein receiving the data generated by the contactless sensor comprises receiving the data generated by at least one of a camera, a vision sensor, an object distance sensor, or an object detection sensor.

14. The method of claim 11, further comprising adapting, by the at least one processor, operations of the packer in response to detecting a material flow anomaly.

15. The method of claim 11, further comprising triggering, by the at least one processor, a visible or audible alert in response to detecting a material flow anomaly.

16. The method of claim 11, further comprising:
receiving, by the at least one processor from a packer load sensor configured to monitor a load applied to or by the packer, packer load data; and
determining, by the at least one processor and based on the packer load data, whether packer load data indicates a material flow anomaly affecting the packer.

17. The method of claim 16, wherein:
the packer comprises an auger; and
determining whether packer load data indicates a material flow anomaly affecting the packer comprises determining, based on the packer load data, a torque associated with the auger.

18. The method of claim 11, wherein:
receiving the data generated by the intake sensor comprises receiving image data; and
the method further comprises determining, by the controller, the condition of the refuse intake volume by performing a pixel analysis on the image data.

19. The method of claim 18, wherein performing the pixel analysis comprises performing an image classification based on a model trained to identify a visible signature of at least one of the auger or the hopper.

20. The method of claim 11, wherein:
receiving the data generated by the intake sensor comprises receiving distance data; and
the method further comprises determining, by the controller, the condition of the refuse intake volume by comparing the distance data to a predetermined threshold.
